(19) United States
(12) Patent Application Publication
(10) Pub. No.: US 2003/0142665 A1
(43) Pub. Date: Jul. 31, 2003

(54) Feedback system for packet switching device with bufferless cascaded switching matrix

(76) Inventors: Andries Van Wageningen, Wijlre (NL); Hans-Jurgen Reumermann, Aachen (DE); Armand Lelkens, Klimmen (NL)

Correspondence Address: PHILIPS ELECTRONICS NORTH AMERICAN CORP, 580 WHITE PLAINS RD, TARRYTOWN, NY, 10591, US

(21) Appl. No.: 10/276,119

(22) PCT Filed: Apr. 8, 2002
(86) PCT No.: PCT/IB02/01275

(30) Foreign Application Priority Data
Apr. 11, 2001 (DE) 10118126.4

(51) Int. Cl. H04Q 11/00

(52) U.S. Cl. 370/386; 370/400

(57) ABSTRACT

The invention relates to a packet switching device having a switching network consisting of a plurality of bufferless switching matrices (6) and a plurality of switching controllers (7) connected to form a matrix or cascade and each associated with a switching matrix (6), the respective result being fed back to the at least one previous switching controller present in the matrix or cascade.

The invention relates to a packet switching device with a switching network.

In the publication “Weighted Arbitration Algorithms with Priorities for Input-Queued Switches with 100% Throughput” by R. Schoenen, G. Post, G. Sander, Broadband Switching Symposium '99, various, weighted switching algorithms of a packet switching device are compared. The switching algorithms attempt, with different switching steps, to prevent a collision between a plurality of packets destined for the same output port of the packet switching device and to reduce data loss or delay resulting therefrom. Cascade control and the action of a feedback system within the switching network of a packet switching device is not taken into account in this publication.

It is an object of the invention to ensure collision-free switching of data in packet form.

Said object is achieved by a packet switching device having a switching network consisting of a plurality of bufferless switching matrices and switching controllers connected to form a matrix or cascade and each associated with a switching matrix, which switching controllers each comprise at least

one identifier analyzer for identifying an input port in a route identifier associated with a packet and for storing connections already granted between input ports and output ports,

one output arbiter for evaluating at least one inquiry sent with a route identifier,

one configuration unit for storing accepted route identifiers,

one identifier grant analyzer for analyzing and modifying the identifiers, coming from the output arbiter, of the granted inquiries,

one input arbiter for evaluating identified and granted inquiries,

one result analyzer for informing the identifier analyzer about accepted connections,

one inquiry cascader for comparing and selecting a result determined locally by the output arbiter and a result obtained by the previous switching controller, and

one grant cascader for comparing and selecting a result determined locally by the input arbiter and a result obtained by the previous switching controller, the respective result being fed back to the previous cascade-connected switching controller.

In switching data transmitted in packet form, a switching device with a bufferless switching matrix has to make use of a switching algorithm which operates as fast as possible.

A packet switching device switches the signaling data and payload data received in packet form at the input port to the appropriate output port.

During generation of a route identifier for controlling the packets by the packet switching device, a port controller responsible for the input port makes use of a table containing the routing and priority information necessary for the route identifier. The routing and priority information indicate the destination output of the packet switching device and the weighting of the inquiry. The weighting may include details of the priority and category of the packets or the queuing time or length of any queue.

The packet switching device consists of a plurality of bufferless switching matrices for connecting input ports and output ports and a plurality of switching controllers for initializing and changing the configuration of the switching matrices and a number of registers in the form of logical queues operating according to the FIFO (First In First Out) principle.

The interface between the port controller and the packet switching device may either consist of two separate lines for signaling data and payload data or part of the port controller is integrated into the packet switching device and the signaling data and payload data are transmitted in multiplexed manner jointly via one line (“in-band control”).

If a bufferless switching matrix is used, a collision between a plurality of packets destined for the same output port leads to packet loss. In order to prevent this loss, the packets are stored temporarily in queues within the port controller. Since cells of uniform length are easier to handle during switching than packets of varying size, the packets arriving at the port controller are divided into cells of uniform length. After successful switching, i.e. accepted allocation of an input port with an output port, has been performed, the cells are removed from the queue.

A cell may either be sent to the packet switching device at the same time as the route identifier or the cell is conveyed separately to the packet switching device once the route identifier has arrived with an inquiry some time previously at the packet switching device and the latter has carried out its preparations for transfer of the cell. Simultaneous forwarding of route identifier and cell is known as “self-routing”. It has the disadvantage that the decision is made in the port controller as to which cell is switched and collision of the cells cannot be prevented thereby. Separate forwarding of the route identifier and the cell cannot substantially reduce loss caused by cell collision.

Another option is to send the route identifier to the packet switching device with a plurality of inquiries, the latter deciding which of the inquiries is accepted in order then to carry out preparations for transfer of the selected cell. This option offers virtually loss-free cell switching.

To increase the capacity of the packet switching device, a plurality of switching matrices are operated in parallel and connected together to form a superordinate matrix. The switching matrices are each controlled individually by a switching controller.

To configure the switching matrices, a switching algorithm distributed over the switching controllers is used to enable the packet switching device to make a global decision.

If the route identifier arriving at the switching controller from the input port contains only a single inquiry for different ports, the final switching decision is applied to the output of each switching controller located in the last row.

In the event that the route identifier arriving at the switching controller from each input port contains a plurality of inquiries (in each cell period) for different output ports, a two-fold switching algorithm is used in switching. One switching algorithm is used to select an inquiry from all the input ports for each output port and the second switching algorithm is used to specify the granted inquiry of an output port for each input port. The results of the switching controllers located in the last row of a cascade are the switches resulting from the first switching algorithm. To determine the granted inquiries of an output port for the interrogating input port which sent the route identifier to the switching controller, the second switching algorithm has to be informed of the result of the first switching algorithm.

Due to the distributed switching controller circuit, a feedback mechanism is necessary to feed back the first switching result, which mechanism is located at the outputs of the switching controllers in the last row of a cascade.

If the route identifier contains a plurality of inquiries for different output ports, feedback may be achieved by various methods.

One option consists in feeding the result back in the reverse direction to the same switching controller and further to distribute it to all the switching controllers connected with said switching controller. Result feedback requires bidirectional connections between the switching controllers.

Another option consists in feeding the result coming from the last switching controller in a column to the first switching controller in the same column, such that the switching controller connections are made to form a loop. This result feedback method is known as switching controller loop-back.

The result of the last switching controller in a column may be fed back to the input port of the same switching controller. This option requires feedback of the switching controller results via an input port multiplexer.

The invention will be further described with reference to examples of embodiments shown in the drawings, to which, however, the invention is not restricted. In the Figures:

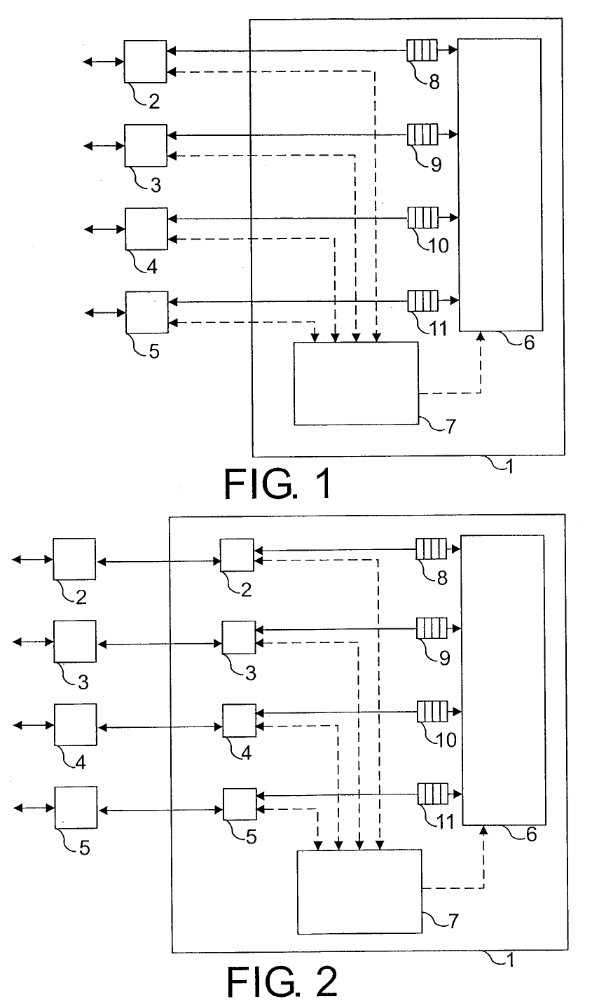

FIG. 1 is a representation of a packet switching device with separate inputs for signaling data and payload data,

FIG. 2 is a representation of a packet switching device with inputs for jointly multiplexed signaling data and payload data (“in-band control”),

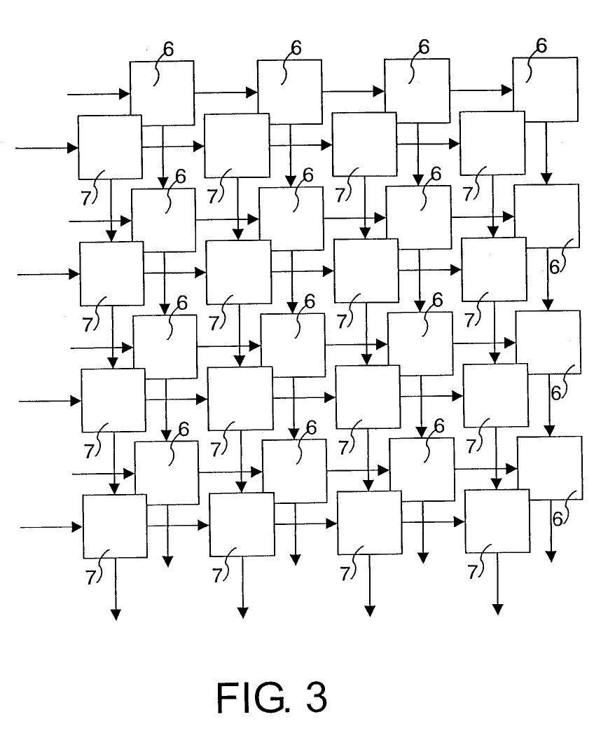

FIG. 3 shows a plurality of switching matrices with a plurality of switching controllers connected to form a cascade,

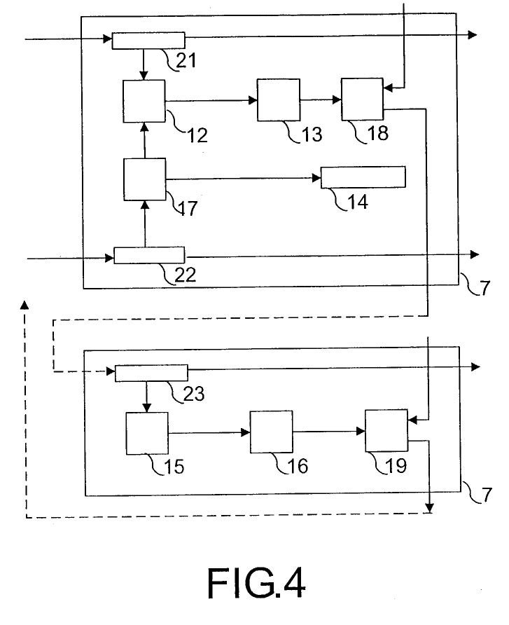

FIG. 4 is a diagram showing the principle of the iterative switching steps,

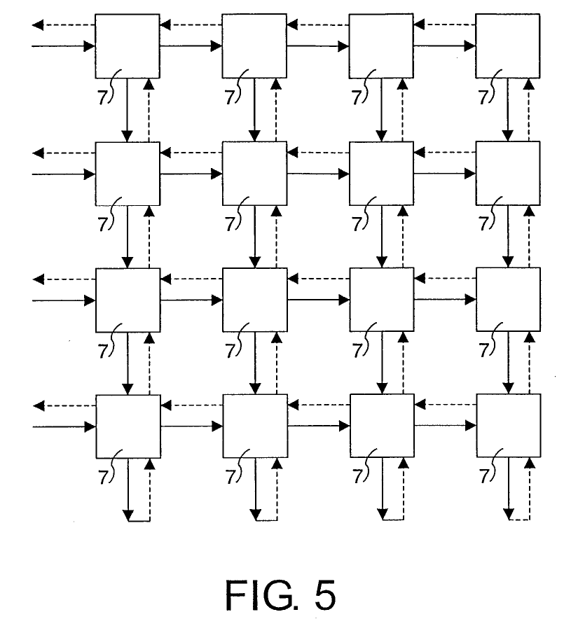

FIG. 5 shows the switching controller circuit during feedback in the reverse direction,

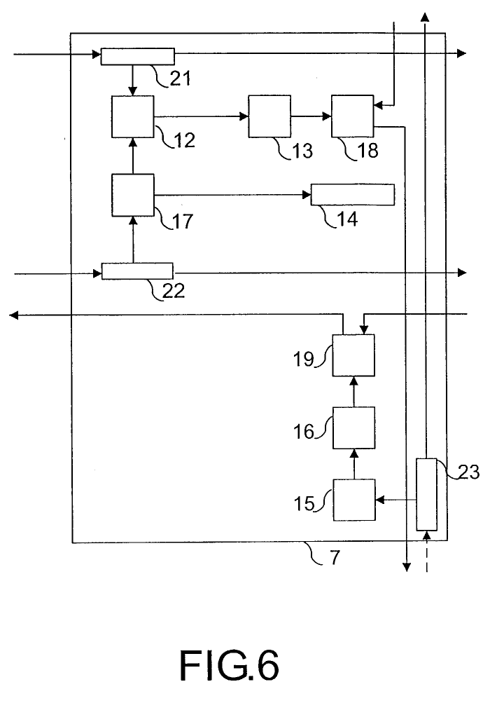

FIG. 6 is a representation of the switching steps during feedback in the reverse direction,

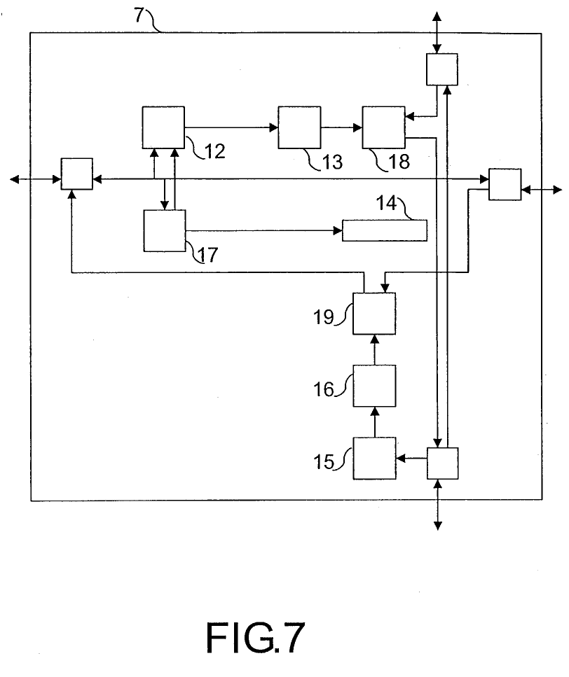

FIG. 7 is a representation of the switching steps during feedback in the reverse direction with bidirectional switching controller in- and outputs,

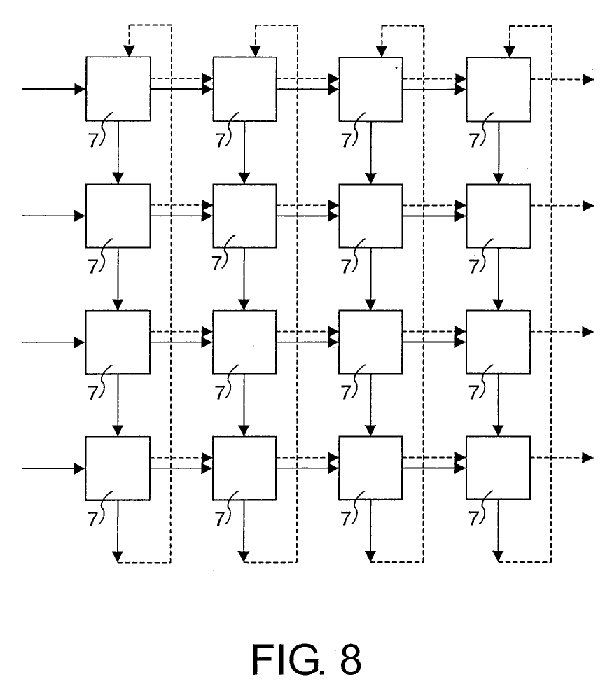

FIG. 8 shows the switching controller circuit during loop-back

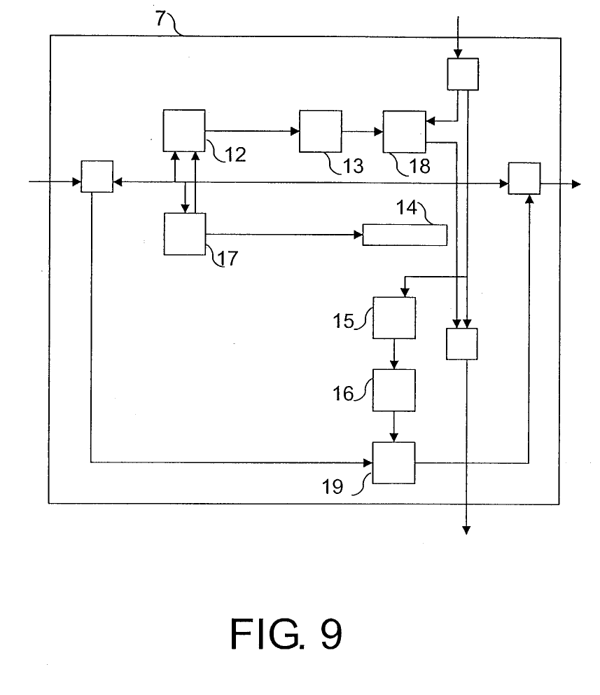

FIG. 9 is a representation of the switching steps during loop-back

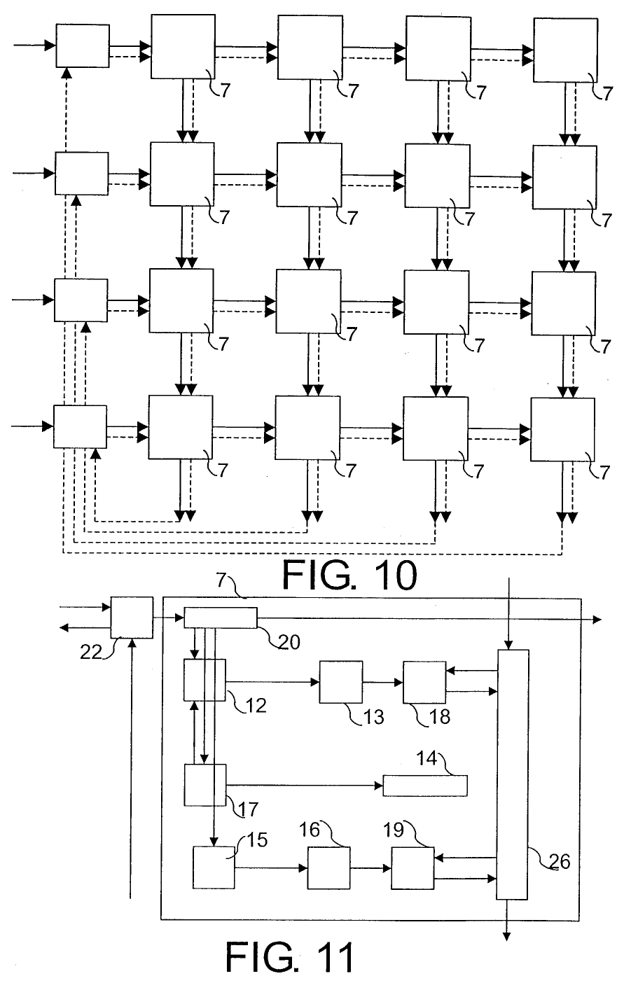

FIG. 10 shows the switching controller circuit during feedback via an input port multiplexer

FIG. 11 is a representation of the switching steps during feedback via an input port multiplexer

The packet switching device 1 shown in FIG. 1 for packet data transport connects a given number of input ports with the corresponding output ports. Information, such as for example a route and priority level, is determined for the packets arriving at the input port in each case by a port controller 2 to 5 by means of switching tables. Once the packets have been divided into cells, the latter are conveyed to the previously determined output line of the packet switching device 1. The switching steps provided for further switching are explained below.

The packet switching device 1 consists of a switching matrix 6, a switching controller 7 and a number of registers 8 to 11 in the form of logical queues operating according to the FIFO (First In First Out) principle.

An alternative representation of the packet switching device 1 is described in more detail with reference to FIG. 2. In contrast to the packet switching device 1 shown in FIG. 1, the port controller 2 to 5 is subdivided into two parts, wherein one part of the port controller 2 to 5 is in each case integrated into the packet switching device (for “in-band control”). As a result, no separate signaling data and payload data connections are provided at the interface between the first part of the port controller 2 to 5 and the packet switching device 1, but rather just one connection, via which the signaling data and payload data are multiplexed and transmitted jointly to the packet switching device 1.

In order to forward cells, the port controller 2 to 5 generates a route identifier with information relating to the input and destination output of the packet switching device and weighting of the inquiry. The weighting may include details of the priority and category of the packets or the queuing time or length of any queue.

Operation of the packet switching device in the event of joint forwarding of the route identifier and the cell is described below. The port controller 2 to 5 conveys the cell to the packet switching device 1 at the same time as the route identifier. Inside the packet switching device, the route identifier is forwarded to the switching controller 7 and the associated cell to the switching matrix, where it is inserted into a register 8 to 11 operating according to the FIFO (First In First Out) principle.

Operation of the packet switching device 1 illustrated in FIGS. 1 and 2 is explained in more detail with reference to the diagrams shown in FIGS. 3 to 11.

FIG. 3 shows the switching controllers 7 and switching matrices 6 connected to form a cascade. The route identifiers sent from the port controllers (2 to 5) are located at the inputs leading to the cascade of switching controllers 7. The results of the switching controllers located lowermost in a row are the resultant switches.

FIG. 4 describes the iterative switching steps of the switching controllers 7 connected to form a cascade. In addition to the switching controller 7, a portion of an adjacent switching controller 20 relevant to result feedback is also shown. The switching controller 20 has a direct connection to the switching controller 7 and is designated the precursor of the switching controller 7. The switching controllers 7 each comprise at least one identifier analyzer 12, one output arbiter 13, one configuration unit 14, one result analyzer 17 and one inquiry cascader 18, together with two refresher units 21 and 22 for amplifying the signals. The portion of the switching controller 20 relevant to signal feedback consists of an identifier grant analyzer 15, a plurality of input arbiters 16, a grant cascader 19 and a refresher unit 23.

The port controller 2 to 5 generates the route identifier, which contains all the destination output numbers of the packet switching device, a plurality of inquiries and their weightings. Said route identifier is forwarded to the switching controller 7, wherein the cells remain in the port controller 2 to 5 and are switched at a later time.

Inside the switching controller 7, the identifier analyzer 12 stores the route identifier signals, refreshed by a refresher 12, for use at a later point for performing iterative switching steps and replaces the destination output numbers with input numbers, such that the source input of the inquiries may be backtracked. At the same time, the refreshed signals are routed on to the next switching controller 7 connected therewith.

The following switching steps are repeated iteratively.

The inquiries processed in the previously performed iterative switching steps, i.e. the connections already granted between the input ports and the output ports of the packet switching device, are stored by the identifier analyzer 12. The modified part of the route identifier for all un-switched inputs is forwarded to the competent output arbiter 13.

A separate output arbiter 13 is responsible for each output port and processes all the inquiries coming from the identifier analyzer 12. On the basis of the route identifier weighting, the output arbiter 13 decides which of the inquiries will be accepted. The selected route identifier is forwarded to an inquiry cascader 18.

The inquiry cascader 18 compares the result of the previous switching controller with the result coming locally from the output arbiter 13. On the basis of the route identifier weighting, the inquiry cascader decides which part of the two results to forward to the subsequent switching controller 7. At the output of the last switching controller 7 in a column, the signal is fed back to the switching controller 20.

Inside the switching controller 20, the signal refreshed by a refresher 23 of the fed-back result is passed to the identifier grant analyzer 15 and at the same time routed on to a next switching controller 7 connected therewith.

The identifier grant analyzer 15 replaces the input number with the destination output number and passes the route identifier on to the competent input arbiter 16.

A separate input arbiter 16 is responsible for each input port and processes the results coming from the identifier analyzer 15. On the basis of the route identifier weighting, the input arbiter 16 decides which of the allocations will be accepted. The selected result is fed to the grant cascader 19.

The grant cascader 19 compares the result of the switching controller 20 with the result obtained locally from the input arbiter 16 (accepted allocation). On the basis of the route identifier weighting, the grant cascader 19 decides for each input port which part of the two results to forward to the subsequent switching controller 7.

The result is forwarded by a refresher 22 to the result analyzer 17 in the first column switching controller 7 and communicated to the interrogating port controller 2 to 5. At the same time, the refreshed signals are sent to the next switching controller 7 connected therewith, such that all the relevant switching controllers are informed of this result.

The result analyzer 17 informs the identifier analyzer 12 of the accepted allocations (result).

The granted route identifiers of the result analyzer 17 are collected in the configuration unit 14, before the configuration unit 14 sends them to the configuration registers of the switching matrix 6. In the next step, the switching controller 7 is appropriately reconfigured for transmission of the cells. Once the interrogating port controller 2 to 5 has received the modified route identifier, the cells are only then sent to the switching matrix 6 and subsequently removed from the queue.

The switching controller 7 illustrated in FIG. 5 shows the circuitry in the event of feedback in the reverse direction. The switching controllers 7 connected to form a cascade match the arrangement described in FIG. 3. In contrast to FIG. 3, the result of the last switching controller in a column is fed back directly to the same switching controller.

The individual switching steps involved in said feedback are explained with reference to FIG. 6. The result of the last switching controller 7 is determined in accordance with the switching steps described in FIG. 4 and at the last switching controller 7 in a column is reintroduced immediately into the same switching controller 7. To ensure that it reaches the interrogating input port, the result is distributed to all the switching controllers 7 connected with this switching controller 7, wherein the result signal is amplified at each switching controller by a refresher 23.

The switching controller illustrated in FIG. 7 consists of the components described in FIG. 6 and fulfills the same functions described with reference to FIG. 6, the difference being that it additionally comprises bidirectional in- and outputs 24.

FIG. 8 shows looping back of the switching controllers 7 connected to form a cascade. With this feedback method, the results of the last switching controller 7 in a column are fed to the inputs of the first switching controllers 7 in these columns, such that the connections of the switching controller 7 in the same column are made to form a loop.

FIG. 9 explains the switching steps of the switching controller with loop-back. The components illustrated in FIG. 9 match the components explained in FIG. 7 and their function. On the basis of the feedback connections connected to form a loop, in- and outputs 24 of the switching controllers 7 are not bidirectional, but rather route the data in one direction to the appropriate components.

FIG. 10 shows feedback of the results of the switching controllers 7 via an input port multiplexer 25. In contrast to the switching controller 7 described in FIG. 8, the result is multiplexed on feedback with other interrogating route identifiers by an input port multiplexer 25 and passed to the input of the switching controller 7. The output port results are each fed back to the inputs of the same input port.

The switching steps involved in feedback via an input port multiplexer are described with reference to FIG. 11. The switching controller 7 comprises the components described in FIG. 6. In addition, a multiplex component 22 is connected to the input of the switching controller 7 and the in- and outputs of the components 18 and 19 are connected with a further multiplex component 26.

The switching result fed back to the input port is passed in multiplexed manner together with the inquiry to the identifier analyzer 15 by the switching controller 7. At the input of the switching controller 7, the result signal, multiplexed with other route identifier data, is amplified by the refresher 20. Further processing of the route identifier and the operation of the components 13 to 19 of the switching controller 7 match that of the components 13 to 19 described in FIG. 6. In contrast to FIG. 4, the in- and outputs of the components 18 and 19 are connected to a multiplexing component 26, such that the data are applied in appropriately multiplexed form to the in- and outputs of the switching controller 7. Each switching controller 7 selects the result for which the switching controller has a connection to the interrogating port controller. As the process continues, the result is cascaded to the interrogating port controller.

1. A packet switching device with a switching network consisting of a plurality of bufferless switching matrices (6) and switching controllers (7) connected to form a matrix or cascade and each associated with a switching matrix (6), which switching controllers (7) each comprise at least
one identifier analyzer (12) for identifying an input port in a route identifier associated with a packet and for storing connections already granted between input ports and output ports,
one output arbiter (13) for evaluating at least one inquiry sent with a route identifier,
one identifier grant analyzer (15) for analyzing and modifying the identifiers, coming from the output arbiter (13), of the granted inquiries,
one input arbiter (16) for evaluating identified and granted inquiries,
one result analyzer (17) for informing the identifier analyzer (12) about accepted connections,
one inquiry cascader (18) for comparing and selecting a result determined locally by the output arbiter (13) and a result obtained by the previous switching controller (7), and
one grant cascader (19) for comparing and selecting a result determined locally by the input arbiter (16) and a result obtained by the previous switching controller (7),
the respective result being fed back to the at least one previous switching controller present in the matrix or cascade.

2. A packet switching device as claimed in claim 1, characterized in that the result is fed back in the reverse direction to the same switching controller (7) and is further distributed to all the switching controllers connected with said switching controller (7).

3. A packet switching device as claimed in claim 1, characterized in that a result coming from the last of all the parallel-connected switching controllers (7) arranged in the same row is fed to the first switching controller arranged in the same row.

4. A packet switching device as claimed in claim 1, characterized in that the matrix consists of a same number M of columns as rows, with in each case a column number m and a row number n, wherein n and m may be allotted a value between 1 and M and in each case the result of a switching controller (7) arranged in the Mth row and mth column is fed back to the input of the first switching controller (7) arranged in the nth row, wherein n is determined as follows: n=(M−m+1).

5. A packet switching device as claimed in claim 1, characterized in that the switching network is connected with a plurality of input ports via multiplexed signaling data and payload data connections.
